(19) United States
(12) Patent Application Publication
(10) Pub. No.: US 2026/0335868 A1
(43) Pub. Date: Oct. 29, 2026

(54) CORE-SHELL-STRUCTURED COMPOSITE PARTICLES AND PREPARATION METHOD THEREFOR

(71) Applicant: QUANTUM CAT CO., LTD., Daejeon (KR)

(72) Inventors: Shinhyun KANG, Sejong (KR); Sunghwan LIM, Sejong (KR); Areum AHN, Daejeon (KR)

(21) Appl. No.: 19/106,209

(22) PCT Filed: Dec. 29, 2022
(86) PCT No.: PCT/KR2022/021665

§ 371 Date: Feb. 25, 2025

(30) Foreign Application Priority Data
Aug. 25, 2022 (KR) 10-2022-0106873

(51) Int. Cl. B01J 23/52; B01D 46/00; B01D 53/86; B01J 21/08; B01J 35/45; B01J 35/50; B01J 37/02; B01J 37/03

(52) U.S. Cl. CPC B01J 23/52; B01D 46/0027; B01D 53/864; B01D 53/8668; B01J 21/08; B01J 35/45; B01J 35/505; B01J 37/0219; B01J 37/0221; B01J 37/0228; B01J 37/0236; B01J 37/0248; B01J 37/038; B01D 2255/106; B01D 2255/9022; B01D 2255/9202; B01D 2257/502; B01D 2257/702; B01D 2257/708; B01D 2258/06

(57) ABSTRACT

The present invention relates to core-shell structured composite particles, and a preparation method therefor, and to core-shell structured composite particles, and a preparation method therefor, the composite particles each comprising: a core including inorganic particles; and a composite catalyst shell which is located on the core, and which includes a porous support including mesopores, and gold nanoparticles impregnated into the pores of the porous support.

### TECHNICAL FIELD

The present disclosure relates to core-shell structured composite particles and a preparation method therefor.

### BACKGROUND ART

Transition metal nanoparticles may exhibit catalytic activity due to a high specific surface area thereof, but since the transition metal nanoparticles usually have an average particle size of 20 nm or less as primary particles, a mesoporous support having a pore size of 2 nm to 50 nm may be considered preferable to support these nanoparticles. The mesoporous support may be made of a metal oxide material, and may be usually known as silica, aluminosilicate, or titania, and depending on a preparation method therefor, mesopores of various sizes and shapes may be formed, and there is an advantage in which the concentration of acid sites and ion exchange capacity may be controlled by controlling the content of a metal or metalloid forming a framework. Accordingly, the mesoporous support is utilized as a support for transition metal nanoparticles, and has the advantage of a rapid reaction rate because the diffusion resistance of materials is lower than that of a microporous support due to the characteristics of the mesopores.

However, the mesoporous support in which the transition metal nanoparticles are supported is prepared as powder particles, and when a state of the powder particles is used as a catalyst, a differential pressure problem occurs as the catalytic reaction progresses. Accordingly, in order to alleviate the differential pressure problem and apply the mesoporous support to a commercial catalytic reaction process, coating should be applied to a substrate having a certain size or larger. In other words, even if a highly active catalyst is developed, a scale-up step suitable for the application environment is essential for final commercialization. For this purpose, there is a method of manufacturing a structural catalyst in the form of a pellet, bead, or honeycomb monolith, but although this method is able to reduce the differential pressure, there is a disadvantage of reducing the efficiency of removing harmful gases due to a decrease in a contact area between the catalyst and the harmful gases, which are catalytic reactants.

Therefore, it is necessary to develop a composite catalyst that may effectively remove harmful gases included in the air while lowering the differential pressure.

### PRIOR ART DOCUMENT

### Patent Document

(Patent Document 1): US 2019-0255520 A1 (Aug. 22, 2019)
(Patent Document 2): KR 10-2017-0119051 A (Oct. 26, 2017)

### SUMMARY OF INVENTION

### Technical Problem

An aspect of the present disclosure is to provide core-shell structured composite particles that may significantly alleviate a differential pressure problem occurring at a high flow rate when using a conventional powder-state catalyst while having significantly excellent catalytic activity at room temperature.

Another aspect of the present disclosure is to provide core-shell structured composite particles that may substantially remove all harmful gases not removed by oxidation reaction alone due to contact between harmful gases and catalysts, even at a high flow rate, by organically combining adsorption and desorption reactions and a catalytic oxidation reaction.

### Solution to Problem

In order to address the above-described aspects, provided are core-shell structured composite particles including: a core including inorganic particles; and a composite catalyst shell disposed on the core, and including a porous support including mesopores and gold nanoparticles impregnated into pores of the porous support.

In an embodiment, the inorganic particles may be porous beads or non-porous beads, and a material of the beads may be one or combinations of two or more selected from the group consisting of glass, carbon, silica, silver-containing inorganic material, alumina-silicate, and alumina.

In an embodiment, the inorganic particles may be porous inorganic particles.

In an embodiment, the porous inorganic particles may be particles including one or combinations of two or more selected from the group consisting of zeolite, activated carbon, porous silica, and porous alumina.

In an embodiment, the porous support may be a metal oxide or metalloid oxide porous support.

In an embodiment, the porous support may further include macropores.

In an embodiment, a diameter of the nanoparticles may be 1 nm to 20 nm.

In an embodiment, the nanoparticles may be impregnated into some of the mesopores of the porous support, and mesopores in which the nanoparticles are not impregnated may be connected to each other as open pores.

In an embodiment, pores of the composite catalyst shell may be connected to pores of the core as open pores.

In an embodiment, a radial distribution function obtained by Fourier transforming an Extended X-ray absorption fine structure (EXAFS) spectrum of the composite catalyst shell may satisfy the following Equation 1,

(DH2/DH1)<0.3 [Equation 1]

In the equation 1, DH1 represents a height of a peak in an interatomic distance D1, and DH2 represents a height of a peak in an interatomic distance D2, and D1 and D2 respectively satisfy the following equations 2 and 3.

0.8≤(D1/D3)≤0.95 [Equation 2]

0.6≤(D2/D3)≤0.7 [Equation 3]

In the equations 2 and 3, D3 represents an interatomic distance of a bulk Au—Au bond present at 2.8 to 3.0 Å.

In an embodiment, the composite catalyst shell may satisfy the following equation 4,

(DA2/DA1)<0.25 [Equation 4]

In the equation 4, DA1 represents an area of a peak in the interatomic distance D1, and DA2 represents an area of a peak in the interatomic distance D2, and D1 and D2 respectively satisfy the equations 2 and 3 described above.

In an embodiment, the composite particles have a bimodal peak in an interatomic distance range of 2.2 Å to 3.0 Å of the radial distribution function.

In an embodiment, a diameter of the core is 100 μm to 50 mm.

In an embodiment, a ratio (T/D) of a diameter (D) of the core and a thickness (T) of the shell is 2×10⁻⁴ to 0.2.

In an embodiment, the composite particles are for an oxidation reaction of carbon monoxide, aldehyde compound or hydrocarbon compound.

Additionally, in another embodiment of the present disclosure, provided is an air purification filter including: a reaction filter unit having has an internal space, the internal space being filled with a plurality of composite particles; an inlet which is provided on one side of the reaction filter unit and through which gas including harmful gases is introduced; and an outlet which is provided on the other side of the reaction filter unit and through which gas from which the harmful gases are removed is discharged.

Additionally, in another embodiment of the present disclosure, provided is a preparation method for core-shell structured composite particles including: an operation (Si) of preparing inorganic particles; an operation (S2) of preparing a dispersion including a composite catalyst including a porous support including mesopores and gold nanoparticles impregnated into pores of the porous support, and a binder; an operation (S3) of applying the dispersion to a surface of the inorganic particles; and an operation (S4) of drying the dispersion.

In an embodiment, the binder may include an inorganic sol binder and a water-soluble polymer binder.

### Advantageous Effects of Invention

Core-shell structured composite particles according to the present disclosure may significantly alleviate a differential pressure problem occurring at a high flow rate when using a conventional powder-state catalyst while having significantly excellent catalytic activity at room temperature.

Core-shell structured composite particles according to the present disclosure may substantially remove all harmful gases not removed by oxidation reaction alone due to contact between harmful gases and catalysts, even at a high flow rate, by organically combining adsorption and desorption reactions and a catalytic oxidation reaction.

### BRIEF DESCRIPTION OF DRAWINGS

FIG. 1 is a mimetic diagram of a core-shell structured composite particles according to an embodiment and a composite catalyst including the same.

FIG. 2 is a schematic diagram of an air purification filter including the composite particles according to an embodiment.

FIG. 3 is an image of core-shell structured composite particles 1 according to Inventive Example 1.

FIGS. 4 to 6 illustrate a radial distribution function obtained by Fourier transforming an EXAFS spectrum of a composite catalyst according to an embodiment.

### BEST MODE FOR INVENTION

In the technical and scientific terms used in the present specification, unless otherwise defined, the terms have the meanings commonly understood by those of ordinary skill in the art to which this invention belongs, and descriptions of well-known functions and configurations that may unnecessarily obscure the gist of the present disclosure in the following description and accompanying drawings will be omitted.

Additionally, the singular form used in the present specification may be intended to include a plural form as well, unless specifically indicated in the context.

Additionally, units used in the present specification without special mention are based on weight, and for example, the unit of % or ratio refers to mass % or mass ratio, and mass % refers to the mass % that any one component of the total composition occupies in the composition, unless otherwise defined.

Additionally, a numerical range used in the present specification includes a lower limit and an upper limit and all values within that range, an increment logically derived from a shape and a width of the defined range, and all possible combinations of double-limited values and the upper limit and the lower limit of a numerical range limited in different forms. Unless otherwise specifically defined in the present specification, values outside the numerical range that may occur due to experimental error or rounding of values are also included in the defined numerical range.

The term “includes” in the present specification is an open-type description equivalent to expressions such as “comprise,” “contains,” “has,” or “characterizes,” and does not exclude additional elements, materials, or processes that are not listed.

The present inventors have recognized that even if the catalytic activity is high, when a powder-state catalyst is used, there is a problem that differential pressure occurs at a high flow rate, making it difficult to commercialize a highly active catalyst. Additionally, as a solution to this problem, the present inventors have recognized that when using a composite catalyst particle coated on a substrate, even if the differential pressure is reduced, there is a problem that harmful gas removal efficiency decreases due to a decrease in a contact area between harmful gases, which are a catalytic reactant, and a catalyst, and have intensified their research to solve this problem. The present inventors have discovered that a core-shell structured composite particles in which a composite catalyst shell including a porous support and gold nanoparticles is located on a core including inorganic particles may solve the above-mentioned problem, and have completed the present disclosure.

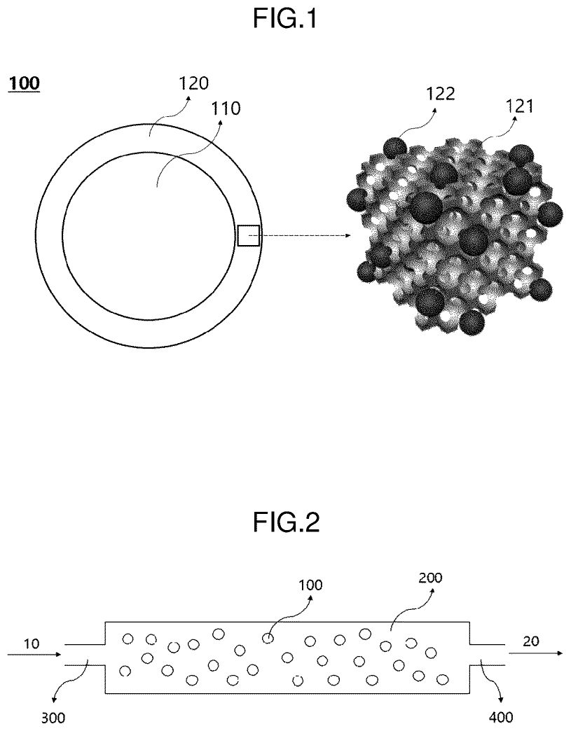

FIG. 1 is a mimetic diagram of a core-shell structured composite particles according to an embodiment and a composite catalyst including the same.

Hereinafter, with reference to the attached drawings, a core-shell structured composite particles according to the present disclosure will be described in detail. The attached drawings are provided only as examples so that the technical idea of the present disclosure may be sufficiently conveyed to technicians, and the present disclosure is not limited to the drawings presented below and may be embodied in various other forms.

Referring to FIG. 1, a core-shell structured composite particles 100 according to the present disclosure include: a core 110 including inorganic particles; and a composite catalyst shell 120 disposed on the core, and including a porous support 121 including mesopores and gold nanoparticles 122 impregnated into the pores of the porous support.

Since the composite particles has the core-shell structure described above, the composite particles may have excellent catalytic activity due to the composite catalyst disposed on a surface of the core, and due to the support of the composite catalyst on the core, a particle size may be increased, thereby improving a differential pressure problem, which is one of the causes of a reduced lifespan of the filter. Additionally, when the composite particles are applied to an air purification filter that needs to fill a certain volume, while conventional powder-type catalysts need to be filled with more catalyst than necessary, the composite particles may be filled with as much catalyst as necessary for air purification, thereby reducing the amount of catalyst used, which is economically advantageous.

According to an embodiment, the inorganic particles may be porous beads or non-porous beads, and specifically, a material of the beads may be one or combinations of two or more selected from the group consisting of glass, carbon, silica, silver-containing inorganic materials, alumina-silicate, and alumina, and more specifically, may be alumina.

According to an embodiment, the inorganic particles may be porous inorganic particles, and the composite particles may include porous inorganic particles as a core, so that not only may the differential pressure occurring at a high flow rate be significantly reduced, but also substantially all of the harmful gases included in the air may be removed even at a high flow rate. Specifically, the harmful gases may be oxidized when the harmful gases come into contact with a surface of the composite catalyst shell or pass from the outside to the inside of the shell, but the harmful gases in the air may not be completely oxidized by contact between the harmful gases and the catalyst alone. The harmful gases not removed by oxidation reaction by contact alone may be rapidly and in large quantities adsorbed inside the core through the pores of the porous inorganic particles, and the harmful gases adsorbed inside the core may be desorbed again and may be oxidized while passing from the inside to the outside of the composite catalyst shell, so that the harmful gases may be substantially completely removed even at a high flow rate. On the other hand, when the inorganic particles are nonporous, an oxidation reaction of the harmful gases by the above-described adsorption/desorption may not occur and the harmful gases may only be oxidized by contact alone on the surface of the composite catalyst shell, so that not all the harmful gases may be removed.

A non-limiting example of the porous inorganic particles may be particles including one or combinations of two or more selected from the group consisting of zeolite, activated carbon, porous silica, and porous alumina. Preferably, the inorganic particles may be activated carbon or zeolite.

According to an embodiment, the porous inorganic particles may be activated carbon particles. The composite particles may include activated carbon particles as a core, so that the adsorption capacity of a harmful substance in the pores of the porous inorganic particles may be increased, so that an oxidation reaction of the harmful gases through adsorption and desorption may occur at a faster rate, and thus, substantially all of the harmful gases may be removed more effectively.

According to an embodiment, the porous inorganic particles may be zeolite particles, and as the composite particles includes zeolite particles as a core, not only may the harmful gases be removed more effectively due to the increase in the adsorption capacity, but also may additionally provide deodorizing and moisture absorption functions due to the moisture desorption characteristics of the zeolite.

According to an embodiment, the porous support may be a metal oxide or a metalloid oxide porous support. A metal or metalloid of the metal oxide or metalloid oxide may be from Group 2 to Group 5, Group 7 to Group 9, and Group 11 to Group 14, and specifically, may be a metal or a metalloid selected from Group 2 to Group 4, Group 13, and Group 14, and more specifically, may be Al, Ti, Zr, or Si.

The porous support may include mesopores, and optionally may further include micropores. In the present disclosure, micropores denote that an average diameter of the internal pores is less than 2 nm, and mesopores denote that an average diameter of the internal pores is 2 nm to 50 nm. A volume of the mesopores of the porous support may be 50% by volume or more, 60% by volume or more, or 70% by volume or more, and an upper limit thereof is not limited, but the volume of the mesopores may be, for example, 100% by volume or less, 95% by volume or less, or 90% by volume or less, or 50 to 100% by volume, specifically 60 to 90% by volume, but this is only an example and is not limited thereto.

According to a non-limiting specific example, the porous support may have a hierarchical porous structure, and may include a structure in which micropores are regularly present and interconnected between the mesopores.

According to a non-limiting specific example, the porous support may further include macropores, and since the porous support includes a certain volume fraction or more of macropores, the diffusion resistance of gas may be significantly reduced.

The gold nanoparticles may be prepared by a method known in the pertinent technical field or may use a commercially available material. Specifically, the gold nanoparticles may be prepared by reducing a gold precursor present in a solution to gold according to a known method (Natan et al., Anal. Chem. 67, 735 (1995)). Examples of the gold precursor may include gold-containing halides, gold-containing nitrates, gold-containing acetates, gold-containing acetylacetonates, or gold-containing ammonium salts, but are not limited thereto. Specifically, the metal precursor may be may be HAuCl₄ or HAuBr₄, and the present disclosure is not limited thereto.

A diameter of the gold nanoparticles may be 1 nm to 20 nm, specifically 1 nm to 15 nm, more specifically 1 nm to 12 nm. The preferable diameter of the gold nanoparticles may be 1 nm to 10 nm, more preferably 1 nm to 8 nm.

According to an embodiment, an average diameter of the nanoparticle may be greater than an average diameter of the mesopores of the porous support. Accordingly, it is possible to generate a deformation of a crystal lattice of the gold nanoparticles impregnated into the mesopores of the porous support, and to induce improvement of the catalytic activity in the room temperature range.

According to an embodiment, the nanoparticles may be impregnated into all of the mesopores of the porous support or may be impregnated into some of the mesopores of the porous support, and may be, specifically, impregnated into some of the mesopores of the porous support. More specifically, the nanoparticles may be irregularly impregnated into some of the mesopores of the porous support. In this case, a structure impregnated into all of the mesopores of the porous support refers to a superlattice structure, specifically, a highly ordered superlattice structure having face-centered cubic (FCC) symmetry. The form in which the nanoparticles are irregularly impregnated into some of the mesopores has an advantage in that gas diffusion may be more effective than the superlattice structure.

According to an embodiment, the nanoparticles may be impregnated into some of the mesopores of the porous support, and the mesopores in which the nanoparticles are not impregnated may be connected to each other as open pores.

Since the composite particles are impregnated into only portions of the pores of the porous support, the diffusion of the harmful gas may be more effectively achieved through the pores in which the nanoparticles connected to each other as open pores are not impregnated. Accordingly, a catalytic reaction rate of the harmful gases within the composite catalyst shell may be increased.

According to an embodiment, pores of the composite catalyst shell may be connected to pores of the core as open pores. When the pores of the core and the pores of the shell are not connected to each other, the material penetration is not properly performed, but even if the material penetration is performed, the rate is significantly reduced, so that the adsorption of the harmful gases to the core does not occur properly, and the removal rate of the harmful gases is reduced. The composite particles may rapidly and extensively adsorb the harmful gases by diffusing the harmful gases into the core due to an increase in the material diffusion rate as the pores of the core and the pores of the shell are connected to each other, and the adsorbed gas may be desorbed and oxidized while passing back from the inside to the outside of the composite catalyst shell, so that substantially all of the harmful gases may be removed even at a higher flow rate.

According to an embodiment, the composite catalyst may have an average particle size of 0.01 μm to 10 μm, specifically 0.05 μm to 5 μm, and more specifically 0.1 μm to 5 μm, and by satisfying the range, the composite catalyst may be more closely bound to the core, thereby improving durability.

In an embodiment, the composite catalyst may have a specific surface area of 300 m²/g or more, 400 m²/g or more, 500 m²/g or more, 600 m²/g or more, 2,000 m²/g or less, or 1,500 m²/g or less, and may be, for example, 300 m²/g to 2,000 m²/g, 400 m²/g to 2,000 m²/g, or 600 m²/g to 1,500 m²/g. The specific surface area of the composite catalyst may be, preferable, 640 m²/g to 1,500 m²/g, and more preferably 700 m²/g to 1,500 m²/g.

In an embodiment, the composite catalyst may have a total pore volume of 0.08 cm³/g to 2.0 cm³/g, 0.08 cm³/g to 1.5 cm³/g, or 0.1 cm³/g to 1.0 cm³/g. The total pore volume of the composite catalyst may be, preferably, 0.12 cm³/g to 1.0 cm³/g, and more preferably 0.15 cm³/g to 1.0 cm³/g or 0.2 cm³/g to 1.0 cm³/g.

According to an embodiment, the composite catalyst complex catalyst may have an average pore diameter smaller than an average diameter of the nanoparticles and may be 1.3 nm or more, 1.5 nm or more, or 2 nm or more.

As the composite catalyst satisfies the specific surface area, the pore volume, and the pore diameter of the above-described range, the diffusion of the harmful gases through the pores may be more effective. Accordingly, the catalytic reaction rate of the harmful gases within the composite catalyst shell may be increased.

According to an embodiment, the composite catalyst shell may include a porous support including mesopores and gold nanoparticles impregnated into the pores of the porous support, and a radial distribution function obtained by Fourier transforming an Extended X-ray absorption fine structure (EXAFS) spectrum may satisfy the following equation 1.

(DH2/DH1)<0.3 [Equation 1]

In the equation 1, DH1 represents a height of a peak in an interatomic distance D1, and DH2 represents a height of a peak in an interatomic distance D2, and D1 and D2 respectively satisfy the following equations 2 and 3. Specifically, the D1 and D2 are interatomic distances of a maximum peak found in a range satisfying the following equations 2 and 3, respectively.

0.8≤(D1/D3)≤0.95 [Equation 2]

0.6≤(D2/D3)≤0.7 [Equation 3]

In the equations 2 and 3, the D2 and D3 represent interatomic distances of a bulk Au—Au bond present at 2.8 to 3.0 Å, and may be specifically interatomic distances of a bulk Au—Au bond present at 2.88 to 2.98 Å, and may more specifically denote standard interatomic distances of 2.90 Å. Specifically, D3 may refer to an interatomic distance of the bulk Au—Au bond present at 2.8 to 3.0 Å, obtained through peak deconvolution, when a peak appears as a single peak with asymmetry or has a bimodal peak. The asymmetry denotes that although the peak has the shape of a single peak (unimodal peak), the left and right sides have asymmetry based on the center of the peak as two peaks overlapping each other.

Specifically, (D1/D3) of the equation 2 may be 0.85 to 0.92, and (D2/D3) of the equation 3 may be 0.63 to 0.66.

According to a specific embodiment, in the equation 1, DH1 may refer to a height of a peak with an interatomic distance of 2.57±0.2 Å, and DH2 may refer to a height of a peak with an interatomic distance of 1.85±0.2 Å. Specifically, DH1 may refer to the height of the peak in the interatomic distance of 2.57±0.1 Å, and DH2 may refer to the height of the peak in the interatomic distance of 1.85±0.1 Å.

Since the composite catalyst satisfies a height ratio of the peak in the interatomic distance D1 and the peak in the interatomic distance D2 of less than 0.3, the catalytic activity may be significantly improved.

EXAFS stands for extended X-ray absorption fine structure, and may analyze the radial distribution or coordination number of gold nanoparticles. For example, when high-energy X-rays are irradiated on gold atoms, the gold atoms included in the gold nanoparticles emit electrons. Accordingly, a radial scattering wave is generated centered on the gold atoms that absorbed the X-rays, and when the electrons emitted from the gold atoms that absorbed the X-rays reach other adjacent atoms (gold or oxygen atoms), electrons are emitted from other adjacent atoms. In this case, a radial scattering wave is generated centered on other adjacent atoms.

The scattered wave generated around the gold atom that absorbed the X-ray and the scattered wave generated around the adjacent other atom (gold or oxygen atom) interfere. In this case, a standing wave is obtained according to the distance between the gold atom that absorbed the X-ray and the other atom (gold or oxygen atom) adjacent to the gold atom. When the standing wave is Fourier transformed, a radial distribution having a peak according to the distance between the gold atom and the other atom (gold or oxygen atom) adjacent to the gold atom is obtained. That is, the radial distribution having the peak according to the distance between the gold (Au) atom and the gold (Au) atom as well as a peak according to the distance between the gold (Au) atom and the oxygen atom having the Au—O bond may be obtained when the gold (Au) atom has a bond with the oxygen atom.

According to an embodiment, (DH2/DH1) of the equation 1 may be 0.25 or less, more specifically, 0.24 or less, and may be non-limitingly 0 or more. According to the numerical range, the catalytic activity of the composite catalyst shell may be significantly improved, so that substantially all of the reactant gas contained in the gas stream may be significantly and rapidly converted into a product gas.

According to an embodiment, the composite catalyst shell may satisfy the following equation 4 in a radial distribution function obtained by Fourier transforming an EXAFS (Extended X-ray absorption fine structure) spectrum.

(DA2/DA1)<0.25 [Equation 4]

In the equation 4, DA1 represents an area of a peak in the interatomic distance D1, and DA2 represents an area of a peak in the interatomic distance D2, and D1 and D2 satisfy the equations 2 and 3, respectively.

According to a specific embodiment, in the equation 4, DA1 may refer to the area of the peak in the interatomic distance of 2.57±0.2 Å, and DA2 may refer to the area of the peak in the interatomic distance of 1.85±0.2 Å. Specifically, DA1 may refer to the area of the peak in the interatomic distance of 2.57±0.1 Å, and DA2 may refer to the area of the peak in the interatomic distance of 1.85±0.1 Å.

As the composite catalyst satisfies a ratio of the peak in the interatomic distance D1 and the area in the interatomic distance D2 of less than 0.25, the catalytic activity may be significantly improved.

According to an embodiment, (DA2/DA1) of the equation 4 may be 0.2 or less, specifically 0.18 or less, more specifically 0.15 or less, and may be non-limitingly 0 or more. As the (DA2/DA1) of the equation 4 has the numerical range, the catalytic activity of the composite catalyst shell may be significantly improved, thus converting all reactant gases included in the gas stream into product gases remarkably quickly.

The numerical ranges of the equations 1 and 4 obtained from the Extended X-ray absorption fine structure (EXAFS) spectrum may be derived by the preparation process of the improved composite catalyst according to the present invention, and may be implemented through an embodiment of the present disclosure, but the numerical ranges of the equations 1 and 4 are not limited to an embodiment.

According to an embodiment, there may be a bimodal peak in the interatomic distance range of 2.2 to 3.0 Å of the radial distribution function obtained by Fourier transforming the Extended X-ray absorption fine structure (EXAFS) spectrum, and the bimodal peak is shown by the bond between gold (Au) and gold (Au) atoms. Specifically, the interatomic distance range of 2.2 to 3.0 Å may be a range in which a distance between gold (Au) atoms and gold (Au) atoms is disposed, and refers to the distribution of the interatomic distance of Au—Au in a crystal lattice.

In the interatomic distance range of 2.2 to 3.0 Å, a typical gold nanoparticle may exhibit a single peak, and having a single peak denotes that the interatomic distance between gold (Au) and gold (Au) atoms is constant in the crystal lattice of the nanoparticle. However, having a bimodal peak may denote that there are different gold (Au)-gold (Au) interatomic distances in the crystal lattice, and although not clearly identified, it is inferred that two different gold (Au)-gold (Au) interatomic distances are generated by the deformation of the crystal lattice due to compressive stress. Since there is the bimodal peak in the range of the interatomic distance of 2.2 to 3.0 Å, significantly excellent catalytic activity may be exhibited even in a low temperature range, and it may be possible to substantially convert all of the reactant gas included in a high-velocity gas stream into a product gas significantly quickly.

According to an embodiment, the composite catalyst shell may be included in an amount of 1 to 50 parts by weight, specifically 5 to 20 parts by weight, relative to 100 parts by weight of the core including the inorganic particles. The composite catalyst shell may be coated on a surface of the core to uniformly form a surface coating layer.

According to an embodiment, the diameter of the core is not particularly limited thereto, but may be, for example, 100 μm to 50 mm, specifically 0.5 mm to 50 mm, more specifically 1 mm to 25 mm, and since the core satisfies the above-described range, the size of the composite particles may be increased, thereby improving the differential pressure problem, which is one of the causes of the reduced lifespan of the filter. At the same time, unlike conventional powder-type catalysts, there is no need to fill in more catalyst than necessary, and only as much catalyst as necessary for the air purification filter may be filled, thereby reducing the amount of catalyst used, which is economically advantageous.

According to an embodiment, the ratio (T/D) of the diameter (D) of the core and the thickness (T) of the shell may be 1×10⁻⁴ to 0.2, specifically 1×10⁻³ to 0.1. As the T/D value satisfies the above-described range, it may be possible to have remarkably excellent catalytic activity at room temperature while significantly alleviating the differential pressure problem occurring when using a conventional powder-state catalyst.

According to an embodiment, a thickness of the shell is not particularly limited thereto, but may be, for example, 1 μm to 1 mm, and specifically 2 μm to 500 μm.

According to an embodiment, the core-shell structured composite particles may have a use for an oxidation reaction of carbon monoxide, an aldehyde-based compound, or a hydrocarbon-based compound. Accordingly, the core-shell structured composite particles according to the present disclosure may be preferably utilized as a solid-phase oxidizing agent for carbon monoxide, an aldehyde-based compound, or a hydrocarbon-based compound. The oxidation reaction may be performed at 0 °C to 60 °C, specifically, the oxidation reaction may be performed at 10 °C to 50 °C, more specifically, the oxidation reaction may be performed at 20 °C to 40 °C, but the present disclosure is not necessarily limited thereto. The aldehyde compound may be acetaldehyde or formaldehyde, but is not limited thereto. The hydrocarbon compound may be an aliphatic or aromatic compound or a volatile organic compound (VOC), and may be exemplified by methane, ethane, propane, butane, benzene, toluene or xylene, but the present disclosure is not limited thereto.

According to an embodiment, the composite particles may be converted into carbon dioxide at room temperature with a conversion efficiency of 80% or more, specifically 85% or more, more specifically 90% or more under the condition of 100 [symbol] /min flow rate of carbon monoxide containing gas having a concentration of 4%. Additionally, under the condition of 140 [symbol] /min flow rate, the composite particles may be converted into carbon dioxide with a conversion efficiency of 80% or more, specifically 85% or more, and more specifically 90% or more at room temperature. The carbon monoxide-containing gas may contain oxygen at a certain content, for example, 2% or more, 4% or more, 10% or more, and not limited to 30% or less, in order to be oxidized. For example, the carbon monoxide-containing gas may be air, and the used gas is not limited thereto if the is a gas containing oxygen at a certain content or more.

FIG. 2 is a schematic diagram of an air purification filter including the composite particles according to an embodiment.

The air purification filter according to the present disclosure includes: a reaction filter unit 200 having an internal space and having a plurality of composite particles filled in the internal space; an inlet 300 which is provided on one side of the reaction filter unit and through which gas 10 including harmful gases is introduced; and an outlet 400 which is provided on the other side of the reaction filter unit through which gas 20 from which the harmful gases are removed is discharged, and the composite particles are composite particles 100 described above.

According to an embodiment, the harmful gases may be one or combinations of two or more selected from the group consisting of carbon monoxide, an aldehyde compound, and a hydrocarbon compound. The aldehyde compound may be acetaldehyde or formaldehyde, but is not limited thereto. The hydrocarbon compound may be an aliphatic or aromatic compound, and examples thereof may include methane, ethane, propane, butane, benzene, toluene, or xylene, but the present disclosure is not limited thereto.

Referring to FIGS. 1 and 2, the harmful gases introduced through the inlet 300 may be substantially completely removed even at a high flow rate through adsorption and desorption reactions and catalytic oxidation reactions in addition to contact with the composite particles 100 filled in the reaction filter unit 200, and may be discharged through the outlet 400.

More specifically, the harmful gases not removed only by the oxidation reaction due to contact may be rapidly and in large quantities adsorbed inside the core through the pores of the porous inorganic particles, and the harmful gases adsorbed inside the core may be desorbed again and may be oxidized while passing back from the inside to the outside of the composite catalyst shell, so that the harmful gases may be substantially completely removed even at a high flow rate.

Additionally, as the size of the composite particles 100 filled in the reaction filter unit 200 increases due to the core-shell structure, the differential pressure problem occurring at a high flow rate when using a conventional powder-type catalyst may be significantly alleviated. Moreover, when applied to an air purification filter that needs to fill a certain volume, while the conventional powder-type catalyst need to be filled with more catalyst than necessary, the composite particles may be filled with only as much catalyst as necessary for air purification, thus reducing the amount of catalyst used, which is economically advantageous.

Although not illustrated in FIG. 2, the air purification filter may further include a particle filter unit removing fine particles between the reaction filter unit 200 and the inlet 300. Accordingly, the air purification filter may remove some of the harmful gases included in the gas before passing through the reaction filter unit 200, thus completely removing the harmful gases included in the gas even at a higher flow rate.

A preparation method for a core-shell structured composite particles according to the present disclosure includes: an operation (Si) of preparing inorganic particles; an operation (S2) of preparing a dispersion including a composite catalyst including a porous support including mesopores and gold nanoparticles impregnated into pores of the porous support, and a binder; (S3) an operation of applying the dispersion to a surface of the inorganic particles; and (S4) an operation of drying the dispersion;

In the preparation method for the composite particles, an order of the operations S1 and S2 is not limited, and the above-mentioned description may be applied to the inorganic particles, the porous support, and the nanoparticles.

In the operation S2, the binder may include an inorganic binder, an organic binder, or combinations thereof, and preferably, the inorganic binder and the organic binder may be used in combination. More preferably, the binder may include an inorganic sol binder and/or a water-soluble polymer binder, and the inorganic sol binder may be, for example, silica sol, but the present disclosure is not limited thereto, and an average particle diameter of the inorganic sol binder may be 1 to 50 nm, and may be included in the dispersion at 0.5 to 3 wt %. The water-soluble polymer binder may be one or two or more selected from the group consisting of polyethylene glycol, polyvinyl alcohol, and poly(N-vinyl pyrrolidone). The water-soluble polymer binder may be included in the dispersion at 1 to 5 wt %. A weight average molecular weight of the water-soluble polymer binder may be 10,000 to 1,000,000 g/mol, but is not limited thereto. Specifically, the binder may be a combination of silica sol and polyvinyl alcohol, and through the combination, the composite catalyst may be firmly bound to the inorganic particles, thereby exhibiting excellent durability.

The dispersion may have a weak acidity of pH 2 to 6 or pH 3 to 5. A solvent of the dispersion is not particularly limited, but may be, for example, water, alcohol, or combinations thereof.

In the operation S3, the dispersion may be applied to the surface of the inorganic particles by a coating method known in the pertinent art, such as spin coating, spray coating, knife coating, roll coating, inkjet printing, or dip coating.

According to an embodiment, after the operation S4 step, an operation of sintering the core-shell structured composite particles prepared by the operations Si to S4 may be further included. The above-mentioned sintering temperature may be 200 °C to 600 °C, specifically 300 °C to 500 °C, but the present disclosure is not particularly limited thereto.

### MODE FOR INVENTION

Hereinafter, inventive examples and experimental examples are specifically exemplified and described. However, the embodiments and inventive examples described below are only illustrative, and the technology described in this specification is not limited thereto.

### <Preparation Example 1> Preparation of Complex Catalyst 1

[Operation]: Preparation of Gold Nanoparticles Functionalized with Polymer

[Operation-1]: Gold nanoparticles stabilized with oleylamine are synthesized according to the following procedure.

First, olein amine was selected as a stabilizer, and a solution composed of 60 mL of tetralin, 60 mL of olein amine, and 0.6 g of HAuCl·H₂O was prepared by stirring at room temperature for 10 minutes. 6 mmol of tetrabutylammonium bromide (TBAB), 6 mL of tetralin, and 6 mL of oleyl amine were mixed by ultrasonic grinding and quickly added to the solution. Then, the solution was stirred at room temperature for 1 hour more, ethanol was added, and centrifugation was performed to precipitate gold nanoparticles. The gold nanoparticle precipitate was redispersed with hexane, and ethanol was added, thus performing centrifugation. The prepared gold nanoparticles had an average particle size of 4 nm, and the prepared gold nanoparticles were dispersed in 100 ml of toluene as they were formed.

[Operation-2]: A surface of the gold nanoparticles was functionalized with thiolated PEG through the following method.

In Operation-1, the gold nanoparticles dispersed in toluene were diluted by adding an additional 100 [symbol] of tetrahydrofuran, and a thiolated polymer was selected to functionalize the surface of the gold nanoparticles by binding the polymer to the surface of the gold nanoparticles, and 1 g of monofunctional polyethylene glycol (aSH-PEG, weight average molecular weight: 1 kDa) whose terminal was substituted with a thiol group was added. After stirring, hexane was added, and centrifugation was performed to precipitate the gold nanoparticles (4-Au-PEG) functionalized with PEG. The 4-Au-PEG obtained by precipitation was dried and dispersed in water.

[Operation 2]: Preparation of Porous Silica in which PEG-Functionalized Gold Nanoparticles were Collected

0.088 g of 4-Au-PEG prepared in the operation 1-2 was mixed with 0.396 g of Pluronic F127 as an activator and uniformly dispersed in 10 mL of 1.6 M HCl aqueous solution, and then, 1.49 g of tetraethylorthosilicate (TEOS) was added to the dispersion. Then, the dispersion of the mixture was stirred for 15 minutes and maintained at room temperature for 40 hours without stirring to prepare a red precipitate. The red precipitate thus formed corresponds to the porous silica encapsulated with PEG-functionalized gold nanoparticles.

### [Operation 3]: Preparation of a Composite Catalyst

The red precipitate prepared in the previous operation was washed with water and dried, and then was sintered step by step at 250 °C for 3 hours, 400 °C for 2 hours, and 500 °C for 2 hours to remove PEG and Pluronic F127 polymers, thus preparing a composite catalyst, which is porous silica in which gold nanoparticles were collected.

### <Preparation Example 2> Preparation of Composite Catalyst 2

The same operations were performed except that a molar ratio of oleinamine and HAuCl·H₂O in Operation-1 of the Preparation Example 1 was adjusted to prepare gold nanoparticles having an average particle size of 10 nm, and thus, a composite catalyst 2, which is porous silica with gold nanoparticles collected, was prepared.

### <Preparation Example 3> Preparation of Composite Catalyst 3

The same operations 1 and 2 were performed except that the molar ratio of oleinamine and HAuCl·H₂O was adjusted in Operation 1-1 of the Preparation Example 1 to manufacture gold nanoparticles having an average particle size of 12 nm. In Operation 3, the red precipitate prepared in the previous operation was washed with water, dried, and then sintered at 450 °C to remove PEG and Pluronic F127 polymers, and thus, a composite catalyst 3, which is porous silica with gold nanoparticles collected, was prepared.

### <Preparation Example 4> Preparation of Composite Catalyst 4

The same operations were performed except that 0.396 g of Pluronic F127 was not used in Operation 2 of the Preparation Example 1, and thus, a composite catalyst 4, which is porous silica with gold nanoparticles collected in a superlattice structure, was prepared.

### <Preparation Example 5> Preparation of Composite Catalyst 5

The same operations were performed except that 0.396 g of Pluronic F127 was not used in Operation 2 of the Preparation Example 2, and thus, a composite catalyst 5, which is porous silica with gold nanoparticles collected in a superlattice structure, was prepared.

### <Preparation Example 6> Preparation of Composite Catalyst 6

The same operations were performed except that 0.396 g of Pluronic F127 was not used in Operation 2 of the Preparation Example 3, and thus, a composite catalyst 6, which is porous silica with gold nanoparticles collected in a superlattice structure, was prepared.

### <Inventive Example 1> Preparation of Core-Shell Structured Composite Particles 1

The composite catalyst 1 prepared in the Preparation Example 1 was mixed in an aqueous solution to 10 wt % and milled to prepare a dispersion. An average particle diameter of the milled composite catalyst powder particles was 0.8 μm. An inorganic binder silica sol having an average particle size of 32 nm, adjusted to pH 4 by adding acetic acid to the dispersion, was mixed to make 1 wt % of the dispersion. Then, an organic binder polyvinyl alcohol was mixed into the dispersion to make 2 wt % of the dispersion, thus preparing a coating slurry.

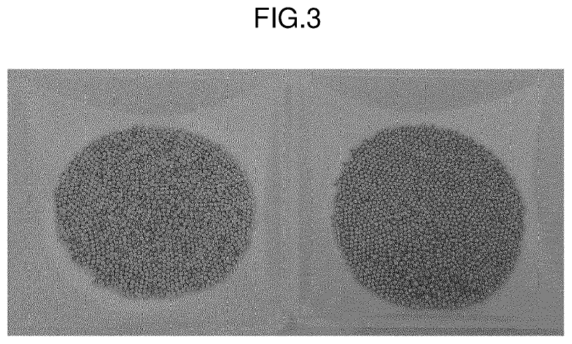

The coating slurry was dip-coated on a surface of zeolite having an average diameter of 2 mm for 5 minutes, and an excessively adhered slurry was removed by blowing air thereonto and then sufficiently dried. The zeolite, which has been coated by repeating the immersion and drying process 10 times, was placed in a high-temperature furnace and sintered at 450 °C for 4 hours, and finally, a core-shell structured composite particles 1 was prepared. FIG. 3 is an image of the core-shell structured composite particles 1.

### <Inventive Example 2> Preparation of Core-Shell Structured Composite Particles 2

The same procedure was performed to prepare core-shell structured composite particles 2 except that the composite catalyst 2 prepared in the Preparation Example 2 was used instead of the composite catalyst 1 prepared in the Preparation Example 1 in the Inventive Example 1.

### <Inventive Example 3> Preparation of Core-Shell Structured Composite Particles 3

The same procedure was performed to prepare core-shell structured composite particles 3 except that the composite catalyst 3 prepared in the Preparation Example 3 was used instead of the composite catalyst 1 prepared in the Preparation Example 1 in the Inventive Example 1.

### <Inventive Example 4> Preparation of Core-Shell Structured Composite Particles 4

The same procedure was performed to prepare core-shell structured composite particles 4 except that the composite catalyst 4 prepared in the Preparation Example 4 was used instead of the composite catalyst 1 prepared in the Preparation Example 1 in the Inventive Example 1.

### <Inventive Example 5> Preparation of Core-Shell Structured Composite Particles 5

The same procedure was performed to prepare core-shell structured composite particles 5 except that the composite catalyst 5 prepared in the Preparation Example 5 was used instead of the composite catalyst 1 prepared in the Preparation Example 1 in the Inventive Example 1.

### <Inventive Example 6> Preparation of Core-Shell Structured Composite Particles 6

The same procedure was performed to prepare core-shell structured composite particles 6 except that the composite catalyst 6 prepared in the Preparation Example 6 was used instead of the composite catalyst 1 prepared in the Preparation Example 1 in the Inventive Example 1.

### Comparative Example 1

The following experimental example was performed using the same amount of the powdered composite catalyst 1 prepared in the Preparation Example 1 as in Inventive Example 1.

### Comparative Example 2

The following experimental example was performed using zeolite having an average diameter of 2 mm.

### <Experimental Example 1> Extended X-Ray Absorption Fine Structure (EXAFS) Analysis

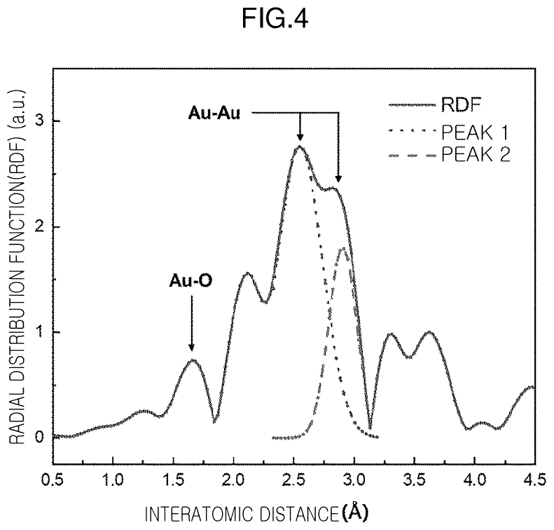

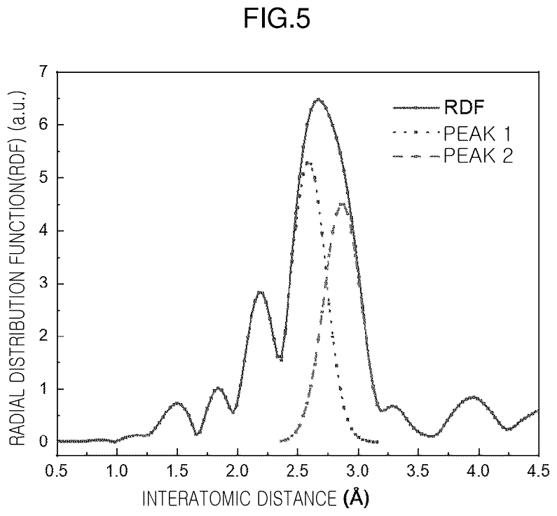

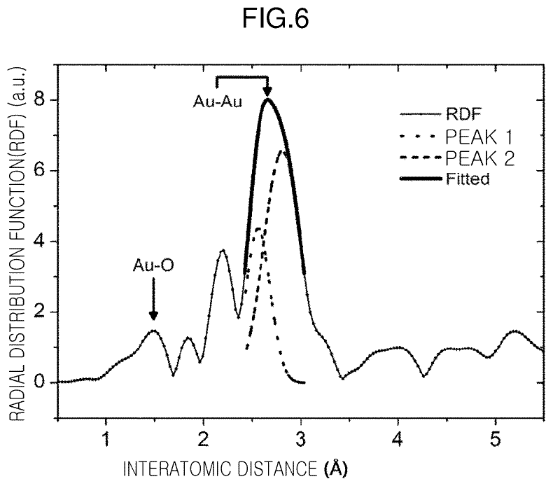

An Extended X-ray absorption fine structure (EXAFS) measurement was performed using the 4 C and 10 C beamlines of the Pohang Accelerator (PLS-II). The EXAFS spectrum was Fourier transformed to obtain the radial distribution function. FIG. 4 illustrates a radial distribution function of a composite catalyst (Preparation Example 1) in which gold particles having an average particle size of 4 nm were supported, FIG. 5 illustrates a radial distribution function of a composite catalyst (Preparation Example 2) in which gold particles having an average particle size of 10 nm were supported, and FIG. 6 illustrates a radial distribution function of a composite catalyst (Preparation Example 3) in which gold particles having an average particle size of 12 nm were supported.

As a result of analyzing the radial distribution functions of the composite particles according to Preparation Examples 1 to 6, all of radial distribution functions exhibited peaks due to Au—O bonds in the range of 1.4 to 1.7 Å. From this, it may be confirmed that the proximity between the surface of the gold nanoparticle and the porous silica collecting the same provides the conditions for forming a stable Au—O bond at an interface between the gold nanoparticle and the porous silica, thereby forming Au—O—Si.

Additionally, in all of FIGS. 1 to 5, a peak due to the bulk Au—Au bond was observed in the range of 2.8 to 3.0 Å, and when the interatomic distance of the peak is referred to as D3, the peak of the radial distribution function was defined based on D3. Specifically, D1 and D2 are the interatomic distances of the maximum peaks found in the range satisfying Equations 2 and 3 below, respectively, and the positions of D1, D2, and D3 are illustrated in Table 1. Additionally, the ratios of a height (DH1) and an area (DA1) of the peak of the interatomic distance D1 and a height (DH2) and an area (DA2) of the peak of the interatomic distance D2 were calculated and are illustrated in Table 1.

0.8<(D1/D3)≤0.95 [Equation 2]

0.6≤(D2/D3)≤0.7 [Equation 3]

TABLE 1

| | INVENTIVE | INVENTIVE | INVENTIVE | INVENTIVE | COMPARATIVE |
|---|---|---|---|---|---|
| | EXAMPLE 1 | EXAMPLE 2 | EXAMPLE 3 | EXAMPLE 4 | EXAMPLE 1 |
| DH2/DH1 | 0 | 0.227 | 0 | 0 | 0.335 |
| DA2/DA1 | 0 | 0.129 | 0 | 0 | 0.227 |
| D1 | 2.5522 Å | 2.5893 Å | 2.5607 Å | 2.5939 Å | 2.567 Å |
| D2 | — | 1.8471 Å | — | — | 1.848 Å |
| D3 | 2.906 Å | 2.8967 Å | 2.9601 Å | 2.9526 Å | 2.8177 Å |
| D1/D3 | 0.8783 | 0.894 | 0.8651 | 0.8785 | 0.911 |
| D2/D3 | — | 0.638 | — | — | 0.656 |

### <Experimental Example 2> Pore Characteristics Analysis

After degassing from 473 K to 20 μTorr for 12 hours, a nitrogen (N₂) adsorption-desorption test was performed at 77 K using a 3Flex adsorption analyzer (Micromeritics). In this case, a volume of adsorbed nitrogen gas molecules and a Brunauer-Emmett-Teller (BET) equation were used to measure a specific surface area and pore characteristics of the composite catalysts according to Preparation Examples 1 to 6, and the results are listed in Table 2 below. Referring to Table 2, the composite catalyst according to Preparation Example 1 has a larger specific surface area, a larger pore volume, and a larger pore diameter than the composite catalyst according to Preparation Example 4, and the composite catalysts according to Preparation Examples 2 and 3 have a larger specific surface area, a larger pore volume, and a larger pore diameter than the composite catalysts according to Preparation Examples 5 and 6, respectively. This difference appears to be due to the fact that the composite catalysts of Preparation Examples 1 to 3 have gold nanoparticles impregnated into a portion of the porous silica surface, whereas the composite catalysts of Preparation Examples 4 to 6 have a superlattice structure in which gold nanoparticles are impregnated into the entire porous silica surface.

TABLE 2

| | PREPARATION | PREPARATION | PREPARATION | PREPARATION | PREPARATION | PREPARATION |
|---|---|---|---|---|---|---|
| | EXAMPLE 1 | EXAMPLE 2 | EXAMPLE 3 | EXAMPLE 4 | EXAMPLE 5 | EXAMPLE 6 |
| SPECIFIC | 733.4 | 661.5 | 633.5 | 248.2 | 190.8 | 89.9 |
| SURFACE | | | | | | |
| AREA(m²/g) | | | | | | |
| PORE | 0.248 | 0.138 | 0.113 | 0.142 | 0.0724 | 0.0284 |
| VOLUME(cm³/g) | | | | | | |
| PORE | 2.349 | 2.133 | 2.549 | 1.061 | 1.208 | 1.257 |
| DIAMETER(nm) | | | | | | |

### <Experimental Example 3> Catalytic Activity and Differential Pressure Evaluation

The catalytic activity and differential pressure evaluation were performed in a tubular reactor in which both sides thereof are open. The composite particles according to the inventive examples and the comparative examples of the present disclosure were mounted in the middle of the tubular reactor, and carbon monoxide-containing gas was supplied to one side of the reactor and the other side of the reactor was connected to a Gas Chromatography (DS Science) to measure the carbon monoxide concentration with a TCD detector (Carboxen 1000), and pressure sensors were installed on both sides of the reactor. A commercially available device was used as the pressure sensor. The carbon monoxide-containing gas used was 4% CO, 20% O₂, and 76% He, and the concentration of carbon monoxide discharged from the other side of the reactor was measured while controlling the supply flow rate at room temperature (25 °C), and a carbon monoxide conversion rate (%) and differential pressure (mbar) according to the supply flow rate are listed in Tables 3 and 4 below, respectively.

TABLE 3

| | SUPPLY FLOW RATE | | | | | |
|---|---|---|---|---|---|---|
| | 80 ml/min | 100 ml/min | 120 ml/min | 140 ml/min | 160 ml/min | 180 ml/min |
| INVENTIVE | 100% | 100% | 100% | 100% | 100% | 100% |
| EXAMPLE 1 | | | | | | |
| INVENTIVE | 100% | 100% | 97% | 91% | 85% | 80% |
| EXAMPLE 2 | | | | | | |
| INVENTIVE | 100% | 100% | 95% | 87% | 80% | 71% |
| EXAMPLE 3 | | | | | | |
| INVENTIVE | 100% | 95% | 88% | 75% | 63% | 55% |
| EXAMPLE 4 | | | | | | |
| INVENTIVE | 96% | 88% | 77% | 65% | 57% | 52% |
| EXAMPLE 5 | | | | | | |
| INVENTIVE | 88% | 77% | 65% | 58% | 51% | 43% |
| EXAMPLE 6 | | | | | | |
| COMPARATIVE | 100% | 100% | 100% | 100% | 100% | 100% |
| EXAMPLE 1 | | | | | | |
| COMPARATIVE | 0 | 0 | 0 | 0 | 0 | 0 |
| EXAMPLE 2 | | | | | | |

TABLE 4

| | SUPPLY FLOW RATE | | | | | |
|---|---|---|---|---|---|---|
| | 80 ml/min | 100 ml/min | 120 ml/min | 140 ml/min | 160 ml/min | 180 ml/min |
| INVENTIVE | 0 | 0 | 0 | 0 | 0 | 0 |
| EXAMPLE 1 | | | | | | |
| INVENTIVE | 0 | 0 | 0 | 0 | 0 | 1 |
| EXAMPLE 2 | | | | | | |
| INVENTIVE | 0 | 0 | 0 | 0 | 0 | 2 |
| EXAMPLE 3 | | | | | | |
| INVENTIVE | 0 | 0 | 0 | 1 | 3 | 4 |
| EXAMPLE 4 | | | | | | |
| INVENTIVE | 0 | 0 | 0 | 3 | 5 | 7 |
| EXAMPLE 5 | | | | | | |
| INVENTIVE | 0 | 0 | 1 | 3 | 6 | 9 |
| EXAMPLE 6 | | | | | | |
| COMPARATIVE | 32 | 39 | 50 | 58 | 66 | 78 |
| EXAMPLE 1 | | | | | | |
| COMPARATIVE | 0 | 0 | 0 | 0 | 0 | 0 |
| EXAMPLE 2 | | | | | | |

Referring to Table 3, all examples exhibited a conversion rate of about 90% at a flow rate of 80 [symbol] /min. Inventive Examples 1 to 3 including a composite catalyst in which gold nanoparticles were incorporated into a portion of the porous silica surface were shown to have superior catalytic activity compared to Inventive Examples 4 to 6 including a composite catalyst in which gold nanoparticles were incorporated into the entire porous silica surface. This is because the catalytic activity was improved when the gold nanoparticles were incorporated into a portion of the pores of the porous support and were connected to each other through open pores in the pores of the porous support and/or the pores of the core and the shell.

Specifically, Inventive Example 1 exhibited a carbon monoxide conversion rate close to 100% even at a fast flow rate of 140 [symbol] /min or more, 160 [symbol] /min or more, or 180 [symbol] /min or more, and Inventive Example 2 exhibited a conversion rate of 90% or more even at a flow rate of 140 [symbol] /min, although the conversion rate was shown to partially decrease at a fast flow rate.

Also, referring to Table 4, it may be confirmed that since the inventive example had the core-shell structure, the inventive example had significantly lower differential pressure than that of Comparative Example 1 having a powder form, and specifically, the differential pressure was low even at a high flow rate of 140 [symbol] /min or more, 160 [symbol] /min or more, or 180 [symbol] /min or more.

As described above, the present disclosure has been described with specific matters and limited embodiments and drawings, but this is provided to help a general understanding of the present disclosure, and the present disclosure is not limited to the aforementioned embodiments, and a person skilled in the art to which the present disclosure pertains may make various changes and modifications.

Accordingly, the concept of the present disclosure should not be limited to the described embodiments, and it will be understood that not only the claims to be described below, but also all those that have equivalent modifications to the claims belong to the scope of the present disclosure.

### Description of Reference Characters

10: GAS INCLUDING HARMFUL GASES
20: GAS FROM WHICH HARMFUL GASES ARE REMOVED
100: CORE-SHELL STRUCTURED COMPOSITE PARTICLES
110: CORE INCLUDING INORGANIC PARTICLES
120: COMPOSITE CATALYST SHELL
121: POROUS SUPPORT
122: GOLD NANOPARTICLES
200: REACTION FILTER UNIT
300: INLET
400: OUTLET

1. Core-shell structured composite particles, comprising:
a core including inorganic particles; and
a composite catalyst shell disposed on the core, and including a porous support including mesopores and gold nanoparticles impregnated into pores of the porous support.

2. The core-shell structured composite particles of claim 1, wherein the inorganic particles are porous beads or non-porous beads, and a material of the beads is one or combinations of two or more selected from the group consisting of glass, carbon, silica, silver-containing inorganic material, alumina-silicate, and alumina.

3. The core-shell structured composite particles of claim 1, wherein the inorganic particles are porous inorganic particles.

4. The core-shell structured composite particles of claim 3, wherein the porous inorganic particles are particles including one or combinations of two or more selected from the group consisting of zeolite, activated carbon, porous silica, and porous alumina.

5. The core-shell structured composite particles of claim 1, wherein the porous support is a metal oxide or metalloid oxide porous support.

6. The core-shell structured composite particles of claim 1, wherein the porous support further includes macropores.

7. The core-shell structured composite particles of claim 1, wherein a diameter of the nanoparticles is 1 nm to 20 nm.

8. The core-shell structured composite particles of claim 1, wherein the nanoparticles are impregnated into some of the mesopores of the porous support, and mesopores in which the nanoparticles are not impregnated are connected to each other as open pores.

9. The core-shell structured composite particles of claim 8, wherein pores of the composite catalyst shell are connected to pores of the core as open pores.

10. The core-shell structured composite particles of claim 1, wherein a radial distribution function obtained by Fourier transforming an Extended X-ray absorption fine structure (EXAFS) spectrum of the composite catalyst shell satisfies the following Equation 1,
(DH2/DH1)<0.3 [Equation 1]
where DH1 represents a height of a peak in an interatomic distance D1, and DH2 represents a height of a peak in an interatomic distance D2, and D1 and D2 satisfy the following equations 2 and 3, respectively,
0.8≤(D1/D3)≤0.95 [Equation 2]
0.6≤(D2/D3)≤0.7 [Equation 3]
where D3 represents an interatomic distance of a bulk Au—Au bond present at 2.8 to 3.0 Å.

11. The core-shell structured composite particles of claim 10, wherein the composite catalyst shell satisfies the following equation 4,
(DA2/DA1)<0.25 [Equation 4]
where DA1 represents an area of a peak in the interatomic distance D1, and DA2 represents an area of a peak in the interatomic distance D2, and D1 and D2 respectively satisfy the equations 2 and 3 above.

12. The core-shell structured composite particles of claim 10, wherein the composite particles have a bimodal peak in an interatomic distance range of 2.2 Å to 3.0 Å of the radial distribution function.

13. The core-shell structured composite particles of claim 1, wherein a diameter of the core is 100 μm to 50 mm.

14. The core-shell structured composite particles of claim 1, wherein a ratio (T/D) of a diameter (D) of the core and a thickness (T) of the shell is 2×10⁻⁴ to 0.2.

15. The core-shell structured composite particles of claim 1, wherein the composite particles are for an oxidation reaction of carbon monoxide, aldehyde compound or hydrocarbon compound.

16. An air purification filter, comprising:
a reaction filter unit having has an internal space, the internal space being filled with a plurality of composite particles;
an inlet which is provided on one side of the reaction filter unit and through which gas including harmful gases is introduced; and
an outlet which is provided on the other side of the reaction filter unit and through which gas from which the harmful gases are removed is discharged,
wherein the composite particles are composite particles according to claim 1.

17. The air purification filter of claim 16, further comprising:
a particle filter unit configured to remove fine particles between the reaction filter unit and the inlet.

18. A preparation method for core-shell structured composite particles, the method comprising:
an operation (Si) of preparing inorganic particles;
an operation (S2) of preparing a dispersion including a composite catalyst including a porous support including mesopores and gold nanoparticles impregnated into pores of the porous support, and a binder;
an operation (S3) of applying the dispersion to a surface of the inorganic particles; and
an operation (S4) of drying the dispersion.

19. The preparation method for core-shell structured composite particles of claim 18, wherein the binder includes an inorganic sol binder and a water-soluble polymer binder.
